(19) United States
(12) Patent Application Publication
(10) Pub. No.: US 2007/0096547 A1
(43) Pub. Date: May 3, 2007

(54) Method for vehicle front brake sizing

(76) Inventors: Paul Gritt, Southfield, MI (US); Richard P. Burns, Rochester Hills, MI (US); Paul B. McCormick, Rochester, MI (US); David Case, Grand Blanc, MI (US); David R. Seifrit JR., Dryden, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/260,626

(22) Filed: Oct. 27, 2005

(51) Int. Cl. B60T 17/00

(52) U.S. Cl. 303/1; 188/382

(57) ABSTRACT

A method is provided for sizing a brake system for an automobile using a processor. The method comprises gathering characteristics of the automobile and then calculating a maximum rotor size based the characteristics. Next, a specific torque required to skid the automobile at a selected deceleration is calculated for the brake system at driver only weight, and then a final brake caliper is selected based on the specific torque requirement and maximum brake rotor size. Finally, the selected rotor and brake caliper is evaluated to determine if thermal dissipation requirements for city driving conditions are met.

### FIELD OF THE INVENTION

The present invention relates to motor vehicle design, and more particularly to a method for sizing the front brakes on a motor vehicle.

### BACKGROUND OF THE INVENTION

Typically, when designing brake systems for motor vehicles, the designers use various prototype samples before arriving at a desired rotor and caliper combination. Then, once the desired rotor and caliper combination is finalized, the designers perform extensive thermal testing and thermal analysis to determine if the rotor and caliper combination can withstand the thermal energy dissipated while braking the motor vehicle. This generally results in increased design time and large prototype tooling costs.

Accordingly, it is desirable to provide a modeling method for front brake sizing which performs mathematical analysis to select and thermally validate a rotor and caliper combination based on the design criteria for the motor vehicle.

### SUMMARY OF THE INVENTION

The present invention provides a method for selecting a brake system for an automobile using a processor. The method comprises gathering characteristics of the automobile and then calculating a maximum rotor size based on these characteristics. Next, a specific torque required to skid the automobile at a selected deceleration is calculated for the brake system at driver only weight, and then a brake caliper is selected based on the specific torque required and maximum brake rotor size. Finally, the selected rotor and brake caliper are evaluated to determine if thermal dissipation requirements for city driving conditions are met.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a two-dimensional view of an automobile employing a brake system sized according to the principles of the present invention;

FIG. 2 is a cross-sectional view of a disc brake in the brake system taken along line 2-2 of FIG. 1;

FIG. 3 is a front view of a rotor sized using the principles of the present invention;

FIG. 4 is a flowchart detailing a rotor and caliper sizing process according to one of various embodiments; and

FIG. 5 is a flowchart detailing a thermal validation process according to one of various embodiments.

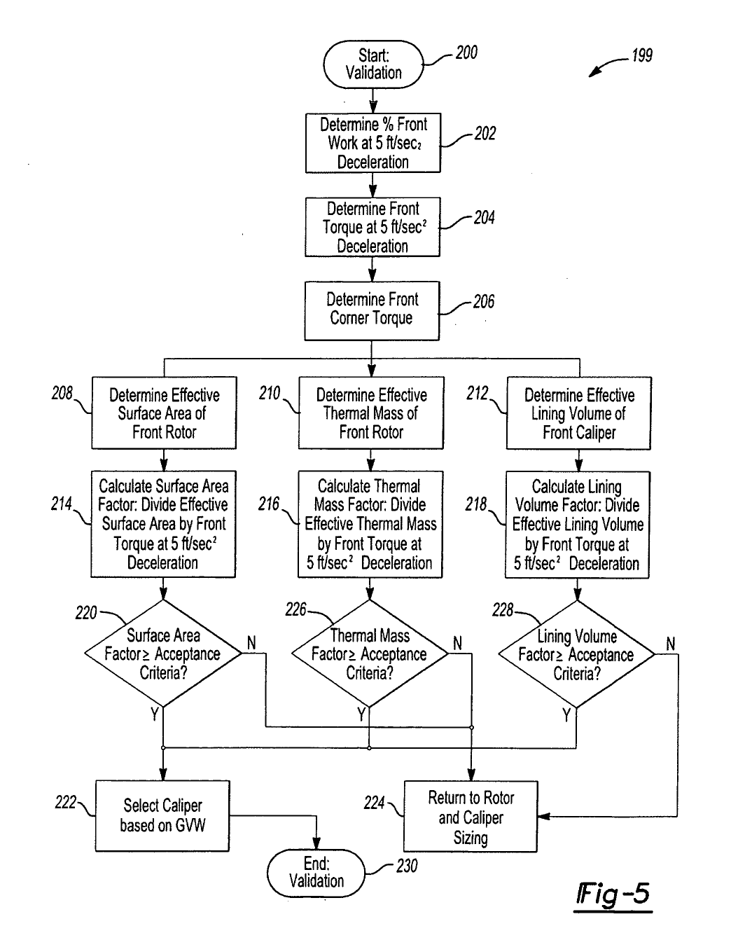

### DETAILED DESCRIPTION OF VARIOUS EMBODIMENTS

The following description of the various embodiments is merely exemplary in nature and is in no way intended to limit the invention, its application, or uses.

The present invention is generally related to a method for vehicle brake sizing. Although the following exemplary description refers to the sizing of front brakes for a vehicle, it will be understood that the present method may be applicable to sizing rear brakes and to other brake applications in general. Also, this methodology could be applied to brake applications including unvented rotors. It will also be understood that the motor vehicle referenced below is an exemplary vehicle, and the foregoing methodology, as applied to this motor vehicle, could be applied to any variety of motor vehicles. Further, the foregoing description is understood to not limit the appended claims.

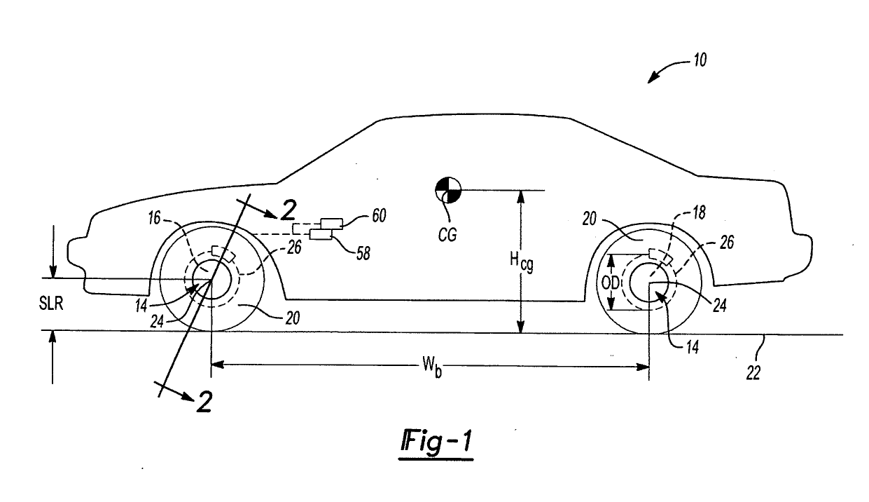

With reference now to FIG. 1, a motor vehicle 10 is shown. Motor vehicle 10 generally includes a brake system 12 coupled to a plurality of wheels 14 with tires 20 mounted thereto. A center of gravity for the motor vehicle 10 is indicated by CG and a wheelbase W_{b} for the motor vehicle 10 is measured as the distance between a front axle 16 and a rear axle 18. The motor vehicle 10 also has a driver only weight DOW calculated as the weight of the motor vehicle 10 containing only the driver (not specifically shown). The height from the center of gravity H_{CG} is measured from the center of gravity CG to a ground 22. The motor vehicle 10 further has a tire static loaded radius SLR which is the distance between a center point 24 of the tire 20 and ground 22 with the weight of the motor vehicle 10 upon the tire 20.

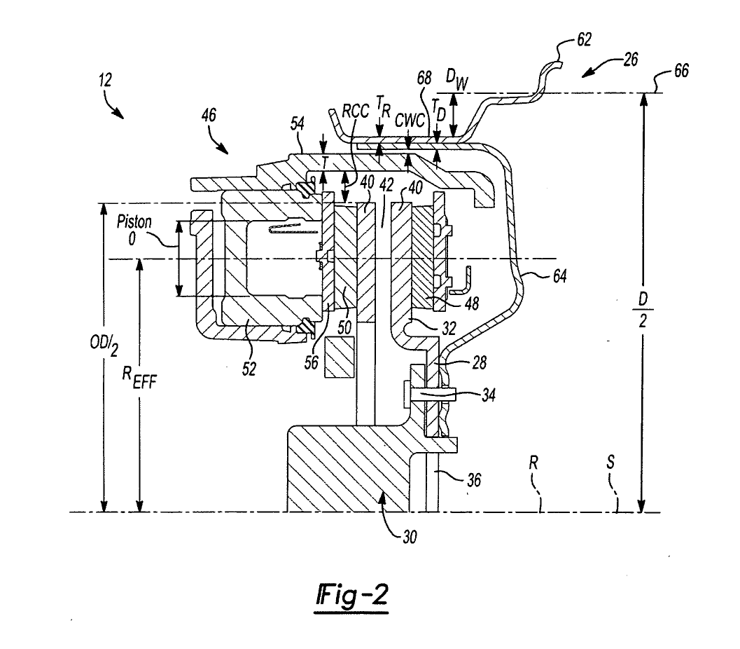

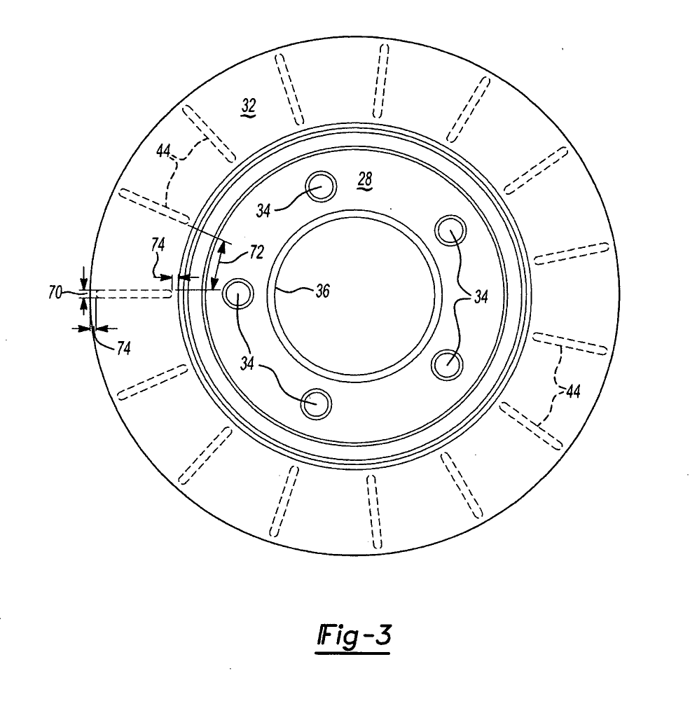

With additional reference to FIGS. 2 and 3, a disc brake 26 of the brake system 12 is shown in greater detail. The disc brake 26 generally includes a rotor 28 with a hub 30 protruding from a body 32 of the rotor 28. The rotor 28 may define a plurality of openings 34 surrounding a central opening 36 for receipt of fasteners to secure the wheel 14 to the hub 30. The central opening 36 is adapted to receive a spindle (not specifically shown) to rotatably couple the rotor 28 to the front axle 16, such that a spindle center line S is equivalent to a rotor center line R. The rotor 28 is generally annular with an outer diameter OD. The body 32 of the rotor 28 includes two discs 40 separated by a vent width 42. A plurality of vanes 44 may be formed between the two discs 40 to provide additional surface area and air flow through the rotor 28 to dissipate thermal energy generated during braking.

A caliper 46 may be disposed adjacent to the rotor 28, with any desired rotor to caliper clearance RCC and desired caliper to rim clearance CWC. The caliper 46 includes a first brake pad 48 and a second brake pad 50, each configured to contact the surface of the rotor 28 to stop the motor vehicle 10 when activated by a piston 52. The first brake pad 48 may be secured with a bridge 54 on the caliper 46 through any appropriate mechanism, such as mechanical fasteners (not specifically shown). The bridge 54 may have any desired thickness T. The second brake pad 50 may be secured to a face 56 of the piston 52 via any suitable mechanism, such as mechanical fasteners (not shown). The piston 52 may be operated by hydraulic fluid provided by a master cylinder 58 and power brake booster 60 (FIG. 1) coupled to the caliper 46. However, the piston 52 may be operated by any suitable mechanism. The activation of the piston 52 causes the first and second brake pads 48, 50 to press against the rotor 28, and will slow the rotation of the rotor 28 and thus wheel 14.

The disc brake 26 can be coupled to the wheel 14 and tire 20 via the openings 34 provided on the hub 30 and the rotor 28. The wheel 14 includes a rim 62 and a disc 64. The rim 62 to supports the tire 20. The rim 62 and disc 64 may have any desired thickness T_{R}, T_{D} respectively. The rim 62 also includes a drop well depth D_{W}, which is the distance between a theoretical cylindrical surface 66 of the wheel 14 and a surface 68 of the rim 62. The distance from the surface 66 of the wheel 14 and the spindle center line S forms the tire and rim association guideline wheel diameter D/2. The tire 20 may be mounted to the rim 62, and depending upon the tire 20, will have a particular tire to ground friction coefficient μ_{T}. Generally, the tire to ground friction coefficient μ_{T} can be 1.0.

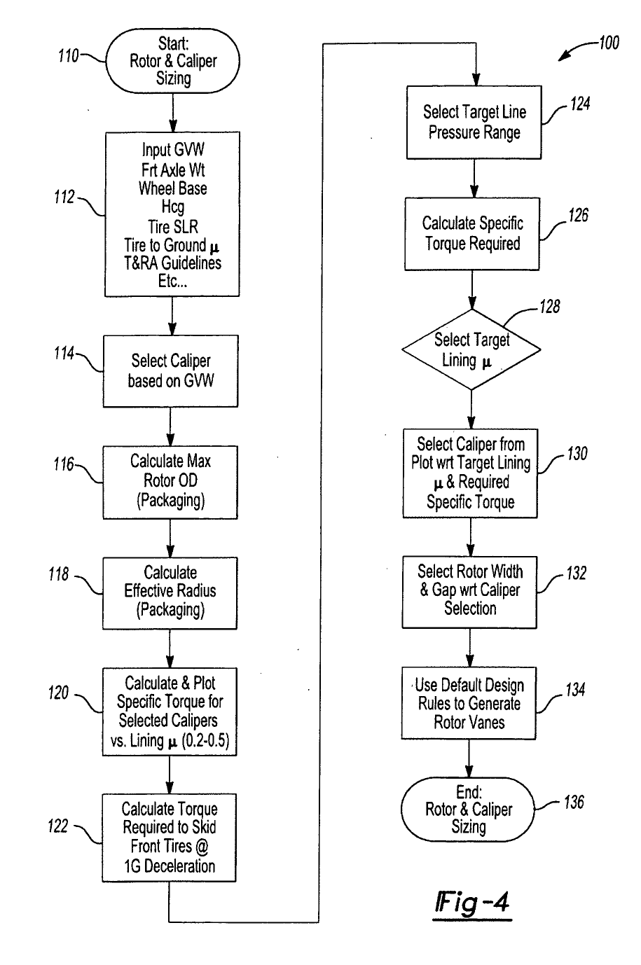

With continuing reference to FIGS. 1, 2 and 3 and additional reference to FIG. 4, a method for vehicle rotor and caliper sizing 100 is illustrated. This program 100 may be implemented upon a processor (not shown).

More specifically, with reference now to FIG. 4, the processor begins in step 110. In step 112, the operator inputs at least a few of the following parameters: the gross vehicle weight GVW in pounds (lbs), the front axle weight (lbs), driver only weight (lbs), wheelbase W_{b} (in), tire static loaded radius SLR (in), tire to ground friction coefficient μ_{T}, (tire and rim guideline wheel diameter) D/2 (in), drop well depth D_{W} (in), rim thickness T_{R} (in), disc thickness T_{D} (in), caliper to wheel clearance CWC (in), caliper bridge thickness T (in), booster size Iₚ and rotor to caliper clearance RCC (in).

Next, in step 114, the processor selects an initial size for the. caliper 46 based on the gross vehicle weight GVW. The size of the caliper 46 selected based on GVW provides a preliminary guideline for a caliper size from which the further calculations are based. Unless the operator inputs a different desired caliper size, the processor will use the smallest caliper available in the GVW range. In step 116, the processor calculates the maximum rotor outer diameter OD. The maximum rotor outer diameter OD is given by the following equation:
MaxRotorOD=2*{(D/2)−D_{W}−T_{R}−T_{D}−CWC−T−RCC)}
wherein D is the tire and rim association guideline wheel diameter, D_{w} is the drop well depth, T_{R} is the rim thickness, T_{D} is the disc thickness, CWC is the caliper to wheel clearance, T is the caliper bridge thickness and RCC is the rotor OD to caliper bridge clearance. If the above values are unknown, or not inputted in step 112, the processor uses default values. These default values are based on standard industry practice.

Next, in step 118, the processor may calculate the effective radius R_{EEF} with respect to the rotor outer diameter from step 1 16. The effective radius R_{EEF} denotes the radial location area of the rotor 28 wherein the force from the first and second brake pads 48, 50 is concentrated during braking. The effective radius R_{EEF} can be determined from the following equation:
R_{Eff}=(RotorOD)/2−(Piston diameter)/2+c₀
wherein the rotor OD is in millimeters, the caliper piston diameter is in millimeters and cₒ is a correction factor depending on type of caliper selected.

In step 120, the processor calculates and plots the specific torque T_{SPEC} for selected calipers against the lining coefficient of friction μ_{L} for the various linings available for a range of calipers. An exemplary range for the lining coefficient of friction μ_{L} can be 0.2-0.6 depending upon the motor vehicle. The specific torque T_{SPEC} can be calculated by the following equation:
T_{Spec}=2*A_{C}μ_{L}*R_{Eff}
wherein A_{C} is the caliper piston area in square inches (in²), R_{EEF} is the effective radius from step 118 in inches (in), μ_{L} is the lining coefficient of friction.

With reference back to FIGS. 1, 2, 3 and 4, in step 122, the processor calculates the brake torque required T_{BRAKE} at driver only weight (DOW) to skid the front tires 20 of the motor vehicle 10 at an assumed deceleration rate of 32 feet per second squared (1 G). The brake torque required T_{BRAKE} can be found by the following equation:
T_{Brake}=[{(DOW*H_{cg}/wb)*D+FrtAxleWt}/2]*SLR*μₜ
wherein DOW is the driver only weight in pounds, D is the deceleration rate 1 G, H_{CG} is the height of the center of gravity in inches, SLR is the tire static loaded radius in inches, W_{b} is the wheelbase in inches, and μ_{T} is the tire to ground friction coefficient. Generally, μ_{T} can be 1.0.

In step 124, the processor acquires the line pressure p_{L} required for the brake system at power brake booster 60 run-out. The line pressure p_{L} may be found by using two different methods. First, if specific characteristics are known, the line pressure p_{L} can be determined from the following equation:
p_{L}=F_{Total}/A_{MC}=((F_{A}+(Fₚ*Iₚ*ηₚ)−F_{S})/A_{MC})*η_{MC}
wherein F_{A} is the booster force, Iₚ is the pedal ratio, η_{MC} is the master cylinder efficiency, Fₚ is the pedal force, ηₚ is the pedal efficiency, F_{S} is the master cylinder spring force and A_{MC} is the master cylinder piston area.

Alternatively, the line pressure p_{L} can be set at a default value of psi based on historical data. Then, the processor in step 126 calculates the specific torque required T_{SPEC,REQD} for the brake system to skid the front tire 20 at a deceleration of 1 G. This can be calculated from the following equation:
T_{Specific,Req'd}=T_{Brake}/p_{L}
wherein T_{BRAKE} is the brake torque required at driver only weight (DOW) determined in step 122 and μ_{L} is the line pressure determined from step 124.

In step 128, the user may input a desired target coefficient of friction μ_{L} for the lining. If no desired value for the lining coefficient of friction was provided in step 112, then the processor assumes a default value based on historical data.

Then, based on the specific torque required T_{SPEC,REQD} calculated in step 126, the processor generates a horizontal line on the plot from step 120 at the specific torque required (T_{SPEC,REQD}). Then the processor plots a vertical line on the plot from step 120 at the target lining coefficient of friction μ_{L}. Based on this plot, the processor may then select a desired caliper 46 based on the specific torque required T_{SPEC,REQD}, the desired coefficient of friction for the lining μ_{L}, from step 128 and the specific torque T_{SPEC} calculated in step 120. Generally, the processor can select the appropriate caliper 46 based on the nearest caliper that is above the intersection of the target coefficient of friction for the lining μ_{L} and the specific torque required T_{SPEC,REQD} by the brake system determined from the plot.

With reference back to FIGS. 1, 2, 3 and 4, after the caliper 46 has been selected, the processor in step 132 selects the standard rotor overall width and vent width associated with the selected size of the caliper 46 from step 130.

Next, in step 134, the processor uses standard design rules to generate the number of vanes 44 for the rotor 28. First, the processor determines a rotor rub track inside diameters ID_{RUBTRACK} for the rotor 28. The processor can assume that the inner diameter of the inboard rub track of the rotor 28 is equivalent to the inner diameter of the outboard rub track and that the wheel 14 is fully supported by the hub 30. Based on these assumptions, the processor uses the following equation to calculate the rotor rub track inside diameter ID_{RUBTRACK}:
ID_{RUBTRACK}=HubFlangeOD+2*(RotortoHubClearance)+2* (RotorHatSideThickness)+(RotorHatODtoRubTrackIDGap)
wherein the hub flange OD, Rotor to Hub Clearance Rotor Hat Side Thickness and Rotor Hat OD to Rub track ID Gap may be default valves or based on user input.

After determining the rotor rub track inside diameters ID_{RUBTRACK} the processor determines a rub track height H_{RUBTRACK} for the rotor 28. The rub track height H_{RUBTRACK} can be found from the following equation:
Height_{RubTrack}=(RotorOD−ID_{RUBTRACK})/2
wherein the rotor OD is the rotor outer diameter calculated in step 116.

Based on the rub track height H_{RUBTRACK} the processor then creates a default configuration for the vanes 44. The default configuration for the vanes 44 may be radial and configured according to a percentage of the total swept area. Vane width 70, vane gap 72 and vane inset 74 are variable depending on manufacturing constraints. The processor may calculate the number of vanes 44 to the nearest prime number based on the following equation:
Qty_{Vanes}=π*(ID_{RUBTRACK}+2*VaneInset)/(VaneWidth+VaneGap)
wherein the ID Rubtrack is the rotor inner diameter determined in step 116.

After determining the quantity of the vanes 44, the processor calculates the length for each of the vanes 44. The length of each of the vanes 44 can be determined from the following equation:
Length=H_{RubTrack}−2*(VaneInset)

After generating the quantity of rotor vanes and length 44 in step 134, ,the processor ends the rotor and caliper sizing program 100 in step 136. With reference now to FIG. 7, in step 200, the processor begins the thermal validation program 199.

Next, in step 202, the processor determines the percent front work done at 5 feet per second squared (ft/sec²) deceleration. Five ft/sec² is the typical deceleration rate for city driving conditions. The percentage of front work done can be determined through two methods. In the first method, a brake simulation program can be run to determine the percent work done. In a second method, a half-vehicle dynamometer test can be run on representative hardware to determine the percentage of front work done. In step 204, the processor determines the front torque at 5 ft/sec² deceleration. The front torque can be determined by the following equation:
FrontTorque=(VehicleWeight/Accel due to gravity)*Decelrate*TireSLR*% FrtWork
wherein the vehicle weight is in pounds, the acceleration due to gravity is in ft/sec² and the tire SLR is from step 112 (in feet) and the percent front work is from step 202.

Next, in step 206, the processor determines the front corner torque at 5 ft/sec² deceleration. The front corner torque can be determined from the following equation:
FrontCornerTorque=FrontTorque/2
wherein the front torque is the front torque determined from step 204.

Next, in step 208, the processor can determine the effective surface area of the rotor 28. The effective surface area of the rotor 28 is calculated based on the rub track area of the rotor plates, the interior rotor area not covered by vanes, the interior rotor area added by vanes and the interior rotor area correction coefficient as shown in the following equations:
Effective Surface Area=2A+D
A=rubtrack area of outboard rotor plate=(π/4)*(RubTrackOD²−RubTrackID²)
B=interior rotor area not covered by vanes=(π/4)*(RubTrackOD²−RubTrackID²)−Qtyᵥₐₙₑₛ*(VaneWidth*Length)
C=interior rotor area added by vanes=Qtyᵥₐₙₑ*(2*VaneWidth+2*Length)*VentWidth
D=interior rotor area correction coefficient=(CF)*(2B+C)ˆ2,
where CF=correction factor for a non-linear surface heat dissipation

The processor may next determine the effective thermal mass of the front rotor in step 210. The effective thermal mass is based on the rub track volume of the rotor plates and the total vane volume. The effective thermal “mass” of the rotor 28 can then be determined by the following equations:
EffectiveThermal “Mass”=2E+F
E=rubtrack volume of one rotor plate=(π/4) *(RubTrackOD²−RubTrackID²)*one Rotor Plate Thickness
F=total vane volume=Qtyᵥₐₙₑ*(VaneWidthLength*VentWidth)

In step 212, the user can enter the effective lining volume. Next, in step 214, the processor calculates the effective surface area factor of the rotor 28. The effective surface area factor is based on the effective surface area calculated in step 208 and the front corner torque calculated in step 204. The effective surface area factor can be given by the following equation:
SurfaceAreaFactor=Effective Surface Area/Front Corner Torque at 5 ft/s² Decel

In step 216, the processor calculates the effective thermal mass factor of the rotor 28. The effective thermal mass factor is based on the effective thermal mass calculated in step 210 and the front corner torque calculated in step 206 and can be found by the following equation:
Thermal “Mass” Factor=Effective Thermal Mass/Front Corner Torque at 5 ft/s² Decel

Then, in step 218 the processor determines the lining volume factor for the rotor 28. The lining volume factor can be found from the following equation:
LiningVolumeFactor=Effective Lining Volume/Front Corner Torque at 5 ft/s² Decel
wherein the effective lining volume was determined in step 212.

Next, in step 220, the processor compares the surface area factor found in step 214 to a surface area factor for a base line vehicle. The base line vehicle may be any suitable vehicle with similar characteristics to the motor vehicle 10. If the surface area factor calculated in step 214 is greater than or equal to an acceptance criteria, the processor continues to step 222. If, however, the surface area factor calculated in step 214 is less than the factor for the base line vehicle or alternate acceptance criteria, the processor goes to step 224 and returns to the rotor and caliper sizing program 100.

Next, the processor compares the thermal mass factor calculated in step 216 to the thermal mass factor calculated for the base line vehicle in step 226. If the thermal mass factor calculated in step 216 is greater than or equal to an acceptance criteria, then the processor continues to step 222. If, however, the thermal mass factor calculated in step 216 is less than the thermal mass factor for the base line vehicle or alternative acceptance criteria, the processor jumps to step 224 and returns to the rotor and caliper sizing program 100.

Next, in step 228, the processor compares the lining volume factor calculated in step 218 to a lining volume factor for a base line vehicle. If the lining volume factor calculated in step 218 is greater than or equal to an acceptance criteria, then the validation is complete in step 230. If, however, the lining volume factor calculated in step 218 is less than the lining volume factor calculated for the base line vehicle or alternative acceptance criteria, the processor jumps to step 224 and returns to the rotor and caliper sizing process. In step 230, the processor ends the validation process and outputs the selected rotor 28 and caliper 46.

The method for vehicle front brake sizing of the present invention enables automobile designers to quickly and easily determine the size of front brakes required for their vehicle. Thus, this method reduces design time and also reduces prototype part costs. In addition, performing thermal validation on the selected rotor 28 and caliper 46 under city driving conditions predicts the ability of the selected brake system 12 to dissipate the thermal energy generated by repeated braking in city traffic conditions and ensures acceptable brake lining life for the brake system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for selecting a brake system for an automobile, the method comprising:
gathering characteristics of the automobile;
calculating a maximum rotor size based on the characteristics;
calculating a specific torque required for the brake system at driver only weight to skid the automobile at a selected deceleration;
selecting a final brake caliper based on the specific torque required and maximum brake size; and
outputting the selected rotor and brake caliper if the rotor and final brake caliper meet predetermined thermal dissipation requirements for city driving conditions.

2. The method of claim 1, wherein the characteristics comprise the gross vehicle weight, the front axle weight, driver only weight, wheelbase, tire static loaded radius, tire to ground friction coefficient, tire and rim guideline wheel diameter, drop well depth, rim thickness, disc thickness, caliper to wheel clearance, caliper bridge thickness, and rotor to caliper clearance.

3. The method of claim 1, further comprising:
selecting a preliminary caliper based on gross vehicle weight;
calculating a maximum rotor outer diameter based on the preliminary caliper and wheel size; and
using default values for the wheel size if no wheel size information is gathered.

4. The method of claim 3, wherein calculating a specific torque required for the brake system further comprises:
calculating a specific torque available from at least one type of caliper based on piston size and a brake pad lining coefficient of friction;
plotting the specific torque calculated against the brake pad lining coefficients of friction; and
calculating the torque required to skid a front tire at a selected deceleration.

5. The method of claim 4, further comprising:
calculating a line pressure required at power brake booster run-out; and
calculating the specific torque required by the brake system to stop the automobile at a selected deceleration based on the specific torque available from the at least one type of caliper and the line pressure required at power brake booster runoff.

6. The method of claim 5, wherein the final caliper is selected based on a caliper which is nearest and above an intersection of the target coefficient of friction for the lining and the amount of specific torque required by the brake system to stop the automobile.

7. The method of claim 5, wherein calculating the line pressure required at power brake booster run-out is calculated based on the characteristics or a given default value.

8. The method of claim 1, further comprising:
selecting a standard rotor width and vent width with respect to the final brake caliper;
determining a rotor rub track inside diameter;
determining a rotor rub track length;
calculating a quantity of vanes for the rotor; and
calculating a length of each vane based on the rub track length.

9. The method of claim 1, wherein the predetermined thermal dissipation requirements comprise:
determining a front corner torque for the selected rotor and final brake caliper to decelerate the motor vehicle at a predetermined amount of deceleration;
determining an effective surface area of the selected rotor;
determining an effective thermal mass of the selected rotor;
determining an effective lining volume of the selected final brake caliper;
calculating a surface area factor from the effective surface area and front corner torque;
calculating a thermal mass factor from the thermal mass and the front corner torque;
calculating a lining volume factor from the effective lining volume and front torque; and
wherein the selected rotor and caliper is outputted if the surface area factor, thermal mass factor and lining volume factor are greater than or equal to a pre-selected acceptance criteria.

10. The method of claim 9, further comprising returning to calculating a maximum rotor size based on the characteristics if the selected rotor and final brake caliper do not meet the pre-selected acceptance criteria.

11. A method for selecting a brake system for an automobile, the method comprising:
gathering at least one characteristic of the automobile;
selecting a preliminary caliper based on the at least one characteristic;
calculating a maximum rotor outer diameter based on the preliminary caliper and wheel size;
calculating a specific torque required for the brake system at driver only weight to skid the automobile at a selected deceleration;
selecting a final brake caliper based on the specific torque required and maximum brake size;
outputting the selected rotor and final brake caliper if the rotor and final brake caliper meet predetermined thermal dissipation requirements; and
incrementing to a new preliminary caliper based on the at least one characteristic if the selected rotor and final brake caliper do not meet the predetermined thermal dissipation requirements.

12. The method of claim 11, wherein the at least one characteristic comprises the gross vehicle weight, the front axle weight, driver only weight, wheelbase, tire static loaded radius, tire to ground friction coefficient, tire and rim guideline wheel diameter, drop well depth, rim thickness, disc thickness, caliper to wheel clearance, caliper bridge thickness, or rotor to caliper clearance, and the caliper is selected based on the gross vehicle weight.

13. The method of claim 11, wherein calculating a maximum rotor size based on the at least one characteristic further comprises:
using default values for the wheel size if no wheel size information is gathered.

14. The method of claim 11, wherein calculating a specific torque required for the brake system further comprises:
calculating a specific torque available from at least one type of caliper based on piston size and a brake pad lining coefficient of friction;
plotting the specific torque calculated against the brake pad lining coefficients of friction; and
calculating the torque required to skid a front tire at a selected deceleration.

15. The method of claim 14, further comprising:
calculating a line pressure required at power brake booster run-out; and
calculating the specific torque required by the brake system to stop the automobile at a selected deceleration based on the specific torque available from the at least one type of caliper and the line pressure required at power brake booster run-out.

16. The method of claim 15, wherein the final brake caliper is based on a caliper which is nearest and above the intersection of the target coefficient of friction for the lining and the amount of specific torque required by the brake system to stop the automobile.

17. The method of claim 15, wherein calculating the line pressure required at power brake booster run-out is calculated based on the at least one characteristic or given a default value.

18. The method of claim 11, further comprising:
selecting a standard rotor width and vent width with respect to the selected final brake caliper;
determining a rotor rub track inside diameters;
determining a rotor rub track length;
calculating a quantity of vanes for the rotor; and
calculating a length of each vane based on the rub track length.

19. The method of claim 11, wherein the predetermined thermal dissipation requirements comprise:
determining a front corner torque for the selected rotor and final brake caliper to decelerate the motor vehicle at a predetermined amount of deceleration;
determining an effective surface area of the selected rotor;
determining an effective thermal mass of the selected rotor;
determining an effective lining volume of the selected final brake caliper;
calculating a surface area factor from the effective surface area and front torque;
calculating a thermal mass factor from the thermal mass and the front torque;
calculating a lining volume factor from the effective lining volume and front torque; and
wherein the selected rotor and final brake caliper is outputted if the surface area factor, thermal mass factor and lining volume factor are greater than or equal to a pre-selected acceptance criteria.
